(19) United States
(12) Patent Application Publication
(10) Pub. No.: US 2019/0303420 A1
(43) Pub. Date: Oct. 3, 2019

(54) SYSTEMS AND METHODS FOR DETERMINING ONE OR MORE USER DEVICES SUITABLE FOR DISPLAYING MEDIA ASSETS MATCHING A SEARCH QUERY

(71) Applicant: Rovi Guides, Inc., San Jose, CA (US)

(72) Inventor: Rahul Bourothu, Burbank, CA (US)

(21) Appl. No.: 16/462,819

(22) PCT Filed: Dec. 15, 2016
(86) PCT No.: PCT/US2016/066884

§ 371 Date: May 21, 2019

(51) Int. Cl. G06F 16/957; G06F 16/9535; G06F 16/906; G06F 16/903; G06F 3/0482; H04N 21/41

(52) U.S. Cl. CPC G06F 16/9577; G06F 16/9535; H04N 21/4122; G06F 16/90348; G06F 3/0482; G06F 16/906

(57) ABSTRACT

Systems and methods for determining one or more user devices suitable for displaying media assets matching a search query. In some aspects, an interactive media guidance application receives, at a first user device, a search query from a user. The interactive media guidance application determines whether a number of the media assets matching the search query exceeds a threshold. Based on determining that the number of the media assets exceeds the threshold, the interactive media guidance application selects a first subset of the media assets not exceeding the threshold. The interactive media guidance application selects a second subset of the media assets not included in the first subset. The interactive media guidance application generates for display, on the first user device, the first subset of the media assets. The interactive media guidance application generates for display, on a second user device, the second subset of the media assets.

### BACKGROUND

The amount of content available to users in any given content delivery system can be substantial. Consequently, many users desire a form of media guidance through an interface that allows users to efficiently navigate content selections and easily identify content that they may desire. Some interfaces may allow user to search for content. For example, such interfaces may be implemented on a set-top box connected to a television display. However, with increasing amounts of available content, browsing search results for a given query, e.g., “action movies,” on a television display may be a difficult task. Browsing multiple search results on the television display may provide for an inefficient user experience as the user may have to scroll through multiple screens to view all search results. Alternatively, more search results may be displayed on a single screen in a smaller font size, but this may also be an inefficient solution as the user may have difficulty reading the search results in the smaller font size.

### SUMMARY

Systems and methods are described herein to address the discussed shortcomings in conventional systems. Conventional systems may display search results for a user's search query on a television display and allow the user to scroll through multiple screens to view all search results and/or reduce the font size to view more search results in a single screen. However, in either case, the user is provided with an inefficient navigation experience that gets increasingly worse as the number of search results increases. The user is either forced to scroll through many, many screens in order to view all search results or offered a screen with a reduced font size that fits more search results but is difficult to read.

To address these shortcomings in conventional systems, the systems and methods described determine one or more user devices suitable for displaying media assets matching a search query. In some aspects, the systems and methods are implemented in an interactive media guidance application that is executed on control circuitry of one or more user devices and/or one or more servers. For example, the interactive media guidance application may be executed on control circuitry of a set-top box, a mobile phone, or another suitable user device. In another example, the interactive media guidance application may be executed on control circuitry of a set-top box and control circuitry of a mobile phone. Each user device may execute stand-alone instances of the interactive media guidance application or each user device may execute different portions of the interactive media guidance application. The interactive media guidance application may receive a search query from a user, e.g., “sports shows,” at a first user device, e.g., a set-top box. The interactive media guidance application may search for media assets matching the search query. For example, the interactive media guidance application may receive 50 search results matching the search query “sports shows.”

The interactive media guidance application may determine whether a number of the media assets matching the search query exceeds a threshold. For example, a television display connected to the set-top box may have a specified threshold of 10 results that are suitable for display to the user. If the number of the media assets matching the search query does not exceed the threshold, the interactive media guidance application may generate for display the search results on the first user device. However, having more than 10 search results may require the user to scroll through multiple screens and/or view the search results in a smaller font size that may be difficult to read. If the number of the media assets matching the search query exceeds the threshold, the interactive media guidance application may select a first subset of the media assets matching the search query and not exceeding the threshold. For example, the interactive media guidance application may select 10 media assets from the 50 media assets in the search results. The interactive media guidance application may select a second subset of the media assets matching the search query and not included in the first subset. For example, the interactive media guidance application may select the remaining 40 media assets from the search results that were not included in the first subset.

The interactive media guidance application may generate for display the first subset of the media assets, e.g., the 10 media assets selected from the search results, on the first user device, e.g., the television display connected to the set-top box. The interactive media guidance application may generate for display the second subset of the media assets, e.g., the 40 remaining media assets from the search results, on a second user device, e.g., a mobile phone. For example, the interactive media guidance application may search a network, including the set-top box, for the mobile phone belonging to the user and push the second subset to the mobile phone. Unlike conventional systems, the described systems and methods provide the user with an opportunity to view the search results on a user device more appropriate for viewing a large number of search results. By viewing the search results on his or her mobile phone, the user may find it easier to efficiently navigate the search results using the mobile phone's touchscreen display.

In some embodiments, the interactive media guidance application selects the first subset of the media assets matching the search query and not exceeding the threshold by ranking the media assets matching the search query based on the user's profile. The interactive media guidance application may retrieve the user's profile from memory and calculate an affinity score for each media asset from the search results with respect to the profile. For example, the interactive media guidance application may calculate a score from 0 to 10 where 0 means no affinity with respect to the user's profile and 10 means very high affinity with respect to the user's profile. For example, if the user's profile indicates the user prefers comedy shows above all other media, the interactive media guidance application may calculate an affinity score close to 10 for a media asset that is a comedy show. The interactive media guidance application may sort the media assets from the search results according to their respective affinity scores. If the threshold is 10 media assets, the interactive media guidance application may select the top 10 media assets from 50 media assets in the search results for display on the first user device. The interactive media guidance application may select the remaining 40 media assets from the search results for display on the second user device. As a result, the media assets with the higher affinity scores with respect to the user's profile may be displayed on the first user device, e.g., the television display connected to the set-top box. If the user is not satisfied with these media assets, the user may review the remaining media assets from the search results on the second user device, e.g., the user's mobile phone.

In some embodiments, the interactive media guidance application determines a minimum font size suitable for displaying search results on the first user device. The interactive media guidance application may use the minimum font size to determine the threshold for how many search results may be generated for display on the first user device such that the user does not have difficulty reading the search results. The interactive media guidance application may query the first user device and receive a display resolution associated with the first user device. For example, the television display connected to the set-top box may have a display resolution of 1920×1080 pixels. The interactive media guidance application may determine the minimum font size based on the display resolution associated with the first user device. The interactive media guidance application may retrieve a reference display resolution, e.g., 1366×768 pixels, and a reference font size, e.g., 20 point. The interactive media guidance application may calculate a ratio of the user's display resolution and the reference display resolution, e.g., 1.4. The interactive media guidance application may adjust the reference font size proportional to the ratio to determine the minimum font size for the first user device, e.g., 28 point. The interactive media guidance application may store, in the memory, the minimum font size suitable for display on the first user device.

In some embodiments, the interactive media guidance application pushes all search results to the second user device, e.g., a mobile phone. Following the example above, the interactive media guidance application may generate for display the selected 10 media assets on the television display connected to the set-top box and generate for display all 50 search results on the mobile phone. Because the user may find the mobile phone more appropriate for viewing a large number of search results, the user may find it more efficient to view all search results on the mobile phone in this instance.

In some embodiments, the interactive media guidance application may generate for display an indication on the first user device. The indication may inform the user that additional search results, beyond the threshold number displayed on the first user device, are available on the second user device. Additionally or alternatively, the interactive media guidance application may generate for display an indication on the second user device. The indication may inform the user that search results for the user's search query are available for display on the second user device. In some embodiments, the user selects the indication on the second user device to view the search results. In some embodiments, the interactive media guidance application automatically pushes search results to the second user device without requiring user input. For example, the interactive media guidance application may automatically populate the user's mobile phone screen with the search results following the input of the search query at the user's set-top box.

In some embodiments, the interactive media guidance application generates for display one or more options for each media asset from the search results. For example, the interactive media guidance application may generate an option to view the media asset, an option to add the media asset to a watch list, or another suitable option. In the instance where the user selects the option to view the media asset on the first user device, e.g., the set-top box, the interactive media guidance application may generate for display the media asset on the first user device. In the instance where the user selects the option to view the media asset on the second user device, e.g., the mobile phone, the interactive media guidance application may generate for display the media asset on the first user device, e.g., the set-top box. Additionally or alternatively, in the instance where the user selects the option to view the media asset on the second user device, e.g., the mobile phone, the interactive media guidance application may generate for display the media asset on the second user device.

In some aspects, the systems and methods described enable a user of a user device, e.g., a set-top box, to reduce the number of navigational key presses required in a search screen featuring an on-screen alphanumeric keypad. For example, the user may wish to search for a media asset on his or her set-top box using an associated remote control device. The interactive media guidance application may generate a search screen for “Search by Title,” “Search by Keyword,” or another suitable search screen. The search screen may include an on-screen alphanumeric keypad for the user to enter his or her search query using the remote control device. However, the user may find it difficult to navigate the keypad by repeatedly pressing the directional keys on the remote control device in order to enter even a simple search. For example, the user may have to press several up/left arrow keys to get to “A” after entering “Y.” The interactive media guidance application may push a notification to another user device, e.g., the user's mobile phone, to allow the user to enter his or her search query using the mobile phone and dramatically decrease the text entry duration. In some embodiments, the interactive media guidance application pushes the notification automatically to the user's mobile phone. In some embodiments, the interactive media guidance application pushes the notification to the user's mobile phone when the user depresses a particular button on the remote control device, e.g., the “B” button, when the search screen is displayed.

In some embodiments, the interactive media guidance application generates for display a notification on the lock screen of the user's mobile phone. The interactive media guidance application may prompt the user to enter the search query on the lock screen itself by interacting with the notification. Additionally or alternatively, the interactive media guidance application may allow the user to invoke another user interface on the mobile phone in order to enter his or her search query. This user interface may allow the user remote access to the set-top box as well in order to search, start, or record media assets on the set-top box remotely. After the user enters his or her search query on the mobile phone screen, the interactive media guidance application may generate for display search results for the search query on the set-top box as if the search query were entered using the set-top box's on-screen alphanumeric keypad. As a result, the user may avoid having to repeatedly press the directional or navigational keys for entering his or her or search query and dramatically reduce the duration of the text entry. Additionally, by promoting the user interface on the mobile phone to the user, the user may be better informed about the options to remotely access the set-top box and decide to use this approach in case he or she finds it more beneficial over using the set-top box's on-screen user interface.

In some aspects, the systems and methods described provide for a method for determining one or more user devices suitable for displaying media assets matching a search query. The interactive media guidance application receives, at a first user device, a search query from a user. The interactive media guidance application searches for media assets matching the search query. The interactive media guidance application determines whether a number of the media assets matching the search query exceeds a threshold. Based on determining that the number of the media assets matching the search query exceeds the threshold, the interactive media guidance application selects a first subset of the media assets matching the search query and not exceeding the threshold. The interactive media guidance application selects a second subset of the media assets matching the search query and not included in the first subset. The interactive media guidance application generates for display, on the first user device, the first subset of the media assets. The interactive media guidance application generates for display, on a second user device, the second subset of the media assets.

In some aspects, the systems and methods described provide for a method for determining one or more user devices suitable for displaying media assets matching a search query. The interactive media guidance application receives, at a first user device, a search query from a user. For example, the interactive media guidance application may receive a search query from a user, e.g., “sports shows,” at a first user device, e.g., a set-top box.

The interactive media guidance application transmits the search query to a database. For example, the interactive media guidance application may transmit the search query to a media content source, a media guidance data source, or another suitable database.

The interactive media guidance application receives, from the database, search result information regarding media assets matching the search query. The search result information includes entries for the media assets matching the search query. For example, the interactive media guidance application may receive search result information including 50 entries for media assets matching the search query.

The interactive media guidance application determines a number of the media assets matching the search query based on the entries included in the search result information. For example, the interactive media guidance application may determine that the 50 media assets match the search query based on the 50 entries included in the search result information.

The interactive media guidance application retrieves, from memory, a minimum font size suitable for display on the first user device. For example, the interactive media guidance application may retrieve from the memory a minimum font size of 28 point as being suitable for displaying search results on the first user device.

In some embodiments, the interactive media guidance application receives a display resolution associated with the first user device. The interactive media guidance application determines the minimum font size based on the display resolution associated with the first user device. For example, the television display connected to the set-top box may have a display resolution of 1920×1080 pixels. The interactive media guidance application may determine the minimum font size based on the display resolution associated with the first user device. The interactive media guidance application may retrieve a reference display resolution, e.g., 1366×768 pixels, and a reference font size, e.g., 20 point. The interactive media guidance application may calculate a ratio of the user's display resolution and the reference display resolution, e.g., 1.4. The interactive media guidance application may adjust the reference font size proportional to the ratio to determine the minimum font size for the first user device, e.g., 28 point. The interactive media guidance application stores, in the memory, the minimum font size suitable for display on the first user device.

The interactive media guidance application determines, based on the minimum font size, a threshold relating to a suitable number of media assets for display on the first user device. For example, the interactive media guidance application may determine that 10 media assets may fit in a single screen when displayed at the minimum font size, 28 point. The interactive media guidance application may select the threshold to be 10 media assets so that the user need not scroll through multiple screens to view the search results.

The interactive media guidance application determines whether the number of the media assets matching the search query exceeds the threshold. For example, the interactive media guidance application may determine whether the 50 media assets from the search results exceed the threshold of 10 media assets.

In some embodiments, based on determining that the number of the media assets matching the search query does not exceed the threshold, the interactive media guidance application generates for display, on the first user device, the media assets matching the search query. For example, if the media assets from the search results do not exceed 10 media assets, the interactive media guidance application may generate for display the media assets on the first user device only.

Based on determining that the number of the media assets matching the search query exceeds the threshold, the interactive media guidance application selects a first subset of the media assets matching the search query and not exceeding the threshold. For example, the interactive media guidance application may determine that the 50 media assets from the search results exceed the threshold of 10 media assets. The interactive media guidance application may select 10 media assets from the search results to include in the first subset.

In some embodiments, the interactive media guidance application selects the first subset of the media assets matching the search query and not exceeding the threshold by ranking the media assets matching the search query based on the user's profile and selecting the first subset based on the ranking of the media assets matching the search query. The interactive media guidance application may retrieve the user's profile from memory and calculate an affinity score for each media asset from the search results with respect to the profile. For example, the interactive media guidance application may calculate a score from 0 to 10 where 0 means no affinity with respect to the user's profile and 10 means very high affinity with respect to the user's profile. For example, if the user's profile indicates the user prefers comedy shows above all other media, the interactive media guidance application may calculate an affinity score close to 10 for a media asset that is a comedy show. The interactive media guidance application may sort the media assets from the search results according to their respective affinity scores. If the threshold is 10 media assets, the interactive media guidance application may select the top 10 media assets from 50 media assets in the search results for display on the first user device.

The interactive media guidance application further selects a second subset of the media assets matching the search query and not included in the first subset. For example, the interactive media guidance application may select the remaining 40 media assets from the search results that were not included in the first subset.

The interactive media guidance application further generates for display, on the first user device, the first subset of the media assets. For example, the interactive media guidance application may generate for display the selected 10 media assets from the first subset on the first user device, e.g., the set-top box.

In some embodiments, the interactive media guidance application generates for display, on the first user device, the first subset of the media assets by generating for display, on the first user device, the first subset of the media assets in the minimum font size. For example, the interactive media guidance application generates for display the first subset of the media assets in the minimum font size of 28 point. Alternatively or additionally, the interactive media guidance application may generate some or all of the media assets in a bigger font. For example, if there is fewer than the threshold number of media assets to be displayed, the interactive media guidance application may select a higher font size than the minimum font size to generate for display the media assets.

The interactive media guidance application further identifies a network associated with the user and including the first user device. For example, the interactive media guidance application may identify a wireless network associated with the user and including the first user device, e.g., the set-top box.

The interactive media guidance application further selects a second user device in the network associated with the user. For example, the interactive media guidance application may select a mobile phone that is in the network and associated with the user.

The interactive media guidance application further generates for display, on the second user device, the second subset of the media assets. For example, the interactive media guidance application may generate for display the second subset of the media assets, e.g., the 40 remaining media assets from the search results, on the second user device, e.g., a mobile phone.

In some embodiments, the interactive media guidance application generates for display, on at least one of the first user device and the second user device, an indication that the number of the media assets matching the search query exceeds the threshold. For example, the indication may inform the user that additional search results, beyond the threshold number displayed on the first user device, are available on the second user device. Additionally or alternatively, the interactive media guidance application may generate for display an indication on the second user device. The indication may inform the user that search results for the user's search query are available for display on the second user device.

In some embodiments, the interactive media guidance application receives, at the at least one of the first user device and the second user device, a user selection of the indication. The second subset of the media assets is generated for display on the second user device based on receiving the user selection of the indication. For example, the user may select the indication on the second user device to view the search results.

In some embodiments, the second subset of the media assets is automatically generated for display on the second user device subsequent to the indication being generated for display on the at least one of the first user device and the second user device. For example, the interactive media guidance application may automatically push search results to the second user device without requiring user input. The interactive media guidance application may automatically populate the user's mobile phone screen with the search results following the input of the search query at the user's set-top box.

In some embodiments, the interactive media guidance application receives, at the first user device, a selection of a media asset from the first subset of the media assets. The interactive media guidance application generates for display, on the first user device, the selected media asset. For example, in the instance where the user selects the option to view the media asset on the first user device, e.g., the set-top box, the interactive media guidance application may generate for display the media asset on the first user device.

In some embodiments, the interactive media guidance application receives, at the second user device, a selection of a media asset from the second subset of the media assets. The interactive media guidance application generates for display, on the first user device, the selected media asset. For example, in the instance where the user selects the option to view the media asset on the second user device, e.g., the mobile phone, the interactive media guidance application may generate for display the media asset on the first user device, e.g., the set-top box.

It should be noted that the systems, methods, apparatuses, and/or aspects described above may be applied to, or used in accordance with, other systems, methods, apparatuses, and/or aspects described in this disclosure.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of an interactive media guidance application implemented on a first user device in accordance with some embodiments of the disclosure;

FIG. 2 shows another illustrative example of an interactive media guidance application implemented on the first user device in accordance with some embodiments of the disclosure;

FIG. 3 shows an illustrative example of an interactive media guidance application implemented on a second user device in accordance with some embodiments of the disclosure;

FIG. 4 shows another illustrative example of an interactive media guidance application implemented on the second user device in accordance with some embodiments of the disclosure;

FIG. 5 shows an illustrative example of a display screen generated by a media guidance application in accordance with some embodiments of the disclosure;

FIG. 6 shows another illustrative example of a display screen generated by a media guidance application in accordance with some embodiments of the disclosure;

FIG. 7 is a block diagram of an illustrative user equipment device in accordance with some embodiments of the disclosure;

FIG. 8 is a block diagram of an illustrative media system in accordance with some embodiments of the disclosure;

FIG. 9 is a flowchart of an illustrative process for determining one or more user devices suitable for displaying media assets matching a search query in accordance with some embodiments of the disclosure;

FIG. 10 is a flowchart of an illustrative process for determining a minimum font size for a user device in accordance with some embodiments of the disclosure; and

FIG. 11 is a flowchart of an illustrative process for selecting the first subset of media assets matching the search query and not exceeding the threshold in accordance with some embodiments of the disclosure.

### DETAILED DESCRIPTION

Systems and methods are described herein for determining one or more user devices suitable for displaying media assets matching a search query. In some aspects, an interactive media guidance application receives, at a first user device, a search query from a user. The interactive media guidance application determines whether a number of the media assets matching the search query exceeds a threshold. Based on determining that the number of the media assets exceeds the threshold, the interactive media guidance application selects a first subset of the media assets not exceeding the threshold. The interactive media guidance application selects a second subset of the media assets not included in the first subset. The interactive media guidance application generates for display, on the first user device, the first subset of the media assets. The interactive media guidance application generates for display, on a second user device, the second subset of the media assets.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Some interfaces may allow user to search for content. For example, such interfaces may be implemented on a set-top box connected to a television display. However, with increasing amounts of available content, browsing search results for a given query, e.g., “action movies,” on a television display may be a difficult task. Browsing multiple search results on the television display may provide for an inefficient user experience as the user may have to scroll through multiple screens to view all search results. Alternatively, more search results may be displayed on a single screen in a smaller font size, but this may also be an inefficient solution as the user may have difficulty reading the search results in the smaller font size.

Systems and methods are described herein to address the discussed shortcomings in conventional systems. Conventional systems may display search results for a user's search query on a television display and allow the user to scroll through multiple screens to view all search results and/or reduce the font size to view more search results in a single screen. However, in either case, the user is provided with an inefficient navigation experience that gets increasingly worse as the number of search results increases. The user is either forced to scroll through many, many screens in order to view all search results or offered a screen with a reduced font size that fits more search results but is difficult to read.

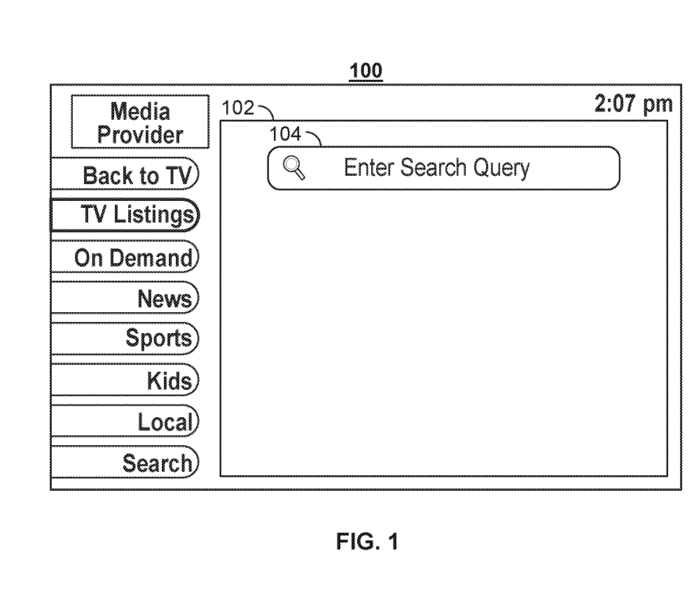

To address these shortcomings in conventional systems, the systems and methods described determine one or more user devices suitable for displaying media assets matching a search query. In some aspects, the systems and methods are implemented in an interactive media guidance application that is executed on control circuitry of one or more user devices and/or one or more servers. For example, FIGS. 1-4 show display screens from illustrative user devices, such as a set-top box and a mobile phone, respectively. For example, the interactive media guidance application may be executed on control circuitry of a set-top box, a mobile phone, or another suitable user device. In another example, the interactive media guidance application may be executed on control circuitry of a set-top box and control circuitry of a mobile phone. Each user device may execute stand-alone instances of the interactive media guidance application or each user device may execute different portions of the interactive media guidance application.

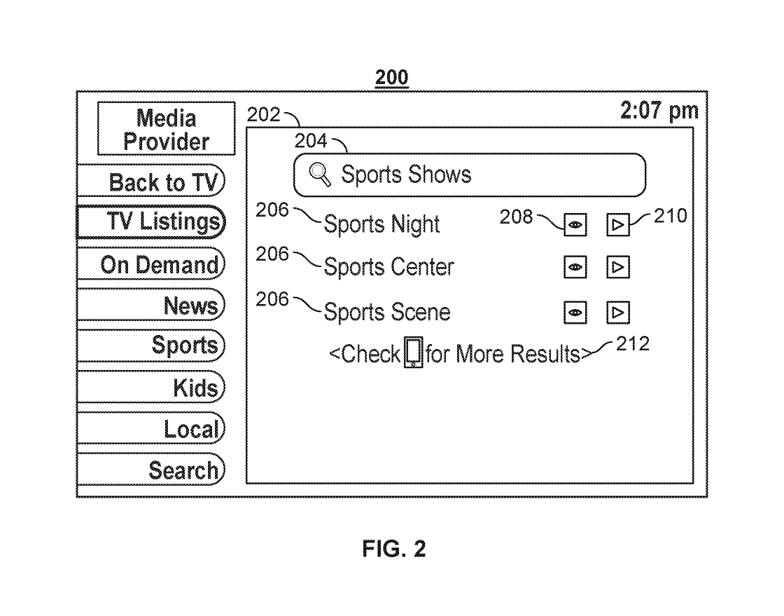

FIGS. 1-2 show illustrative examples 100 and 200 of an interactive media guidance application implemented on a first user device in accordance with some embodiments of the disclosure. The interactive media guidance application may receive via a search screen 102 a search query 104 from a user, e.g., “sports shows,” at a first user device, e.g., a set-top box. The interactive media guidance application may search for media assets matching the search query. For example, the interactive media guidance application may receive in updated search screen 202 the search results 206, e.g., 10 search results, matching the search query 204, “sports shows.”

The interactive media guidance application may determine whether a number of the media assets matching the search query exceeds a threshold. For example, a television display connected to the set-top box may have a specified threshold of three results that are suitable for display to the user. If the number of the media assets matching the search query does not exceed the threshold, the interactive media guidance application may generate for display the search results on the first user device. However, having more than three search results may require the user to scroll through multiple screens and/or view the search results in a smaller font size that may be difficult to read. If the number of the media assets matching the search query exceeds the threshold, the interactive media guidance application may select a first subset of the media assets matching the search query and not exceeding the threshold. For example, the interactive media guidance application may select three media assets from the 10 media assets in the search results. The interactive media guidance application may generate for display the first subset of the media assets, e.g., the three media assets selected from the search results, on the first user device, e.g., the television display connected to the set-top box.

In illustrative example 200, the interactive media guidance application generates for display an indication 212 on search screen 202 of the first user device. The indication may inform the user that additional search results, beyond the threshold number displayed on the first user device, are available on the second user device. Additionally or alternatively, the interactive media guidance application may generate for display an indication on the second user device. The indication may inform the user that search results for the user's search query are available for display on the second user device. In some embodiments, the user selects the indication on the second user device to view the search results. In some embodiments, the interactive media guidance application automatically pushes search results to the second user device without requiring user input. For example, the interactive media guidance application may automatically populate the user's mobile phone screen with the search results following the input of the search query at the user's set-top box.

In illustrative example 200, the interactive media guidance application generates for display options 208 and 210 for each media asset from the search results. In particular, the interactive media guidance application generates an option 208 to add the media asset to a watch list and an option 210 to view the media asset. If the user selects the option to view the media asset on the first user device, e.g., the set-top box, the interactive media guidance application may generate for display the media asset on the first user device.

In some embodiments, the interactive media guidance application selects the first subset of the media assets matching the search query and not exceeding the threshold by ranking the media assets matching the search query based on the user's profile. The interactive media guidance application may retrieve the user's profile from memory and calculate an affinity score for each media asset from the search results with respect to the profile. For example, the interactive media guidance application may calculate a score from 0 to 10 where 0 means no affinity with respect to the user's profile and 10 means very high affinity with respect to the user's profile. For example, if the user's profile indicates the user prefers comedy shows above all other media, the interactive media guidance application may calculate an affinity score close to 10 for a media asset that is a comedy show. The interactive media guidance application may sort the media assets from the search results according to their respective affinity scores. If the threshold is three media assets, the interactive media guidance application may select the top three media assets from the 10 media assets in the search results for display on the first user device. The interactive media guidance application may select the remaining seven media assets from the search results for display on the second user device. As a result, the media assets with the higher affinity scores with respect to the user's profile may be displayed on the first user device, e.g., the television display connected to the set-top box. If the user is not satisfied with these media assets, the user may review the remaining media assets from the search results on the second user device, e.g., the user's mobile phone.

In some embodiments, the interactive media guidance application determines a minimum font size suitable for displaying search results on the first user device. The interactive media guidance application may use the minimum font size to determine the threshold for how many search results may be generated for display on the first user device such that the user does not have difficulty reading the search results. The interactive media guidance application may query the first user device and receive a display resolution associated with the first user device. For example, the television display connected to the set-top box may have a display resolution of 1920×1080 pixels. The interactive media guidance application may determine the minimum font size based on the display resolution associated with the first user device. The interactive media guidance application may retrieve a reference display resolution, e.g., 1366×768 pixels, and a reference font size, e.g., 20 point. The interactive media guidance application may calculate a ratio of the user's display resolution and the reference display resolution, e.g., 1.4. The interactive media guidance application may adjust the reference font size proportional to the ratio to determine the minimum font size for the first user device, e.g., 28 point. The interactive media guidance application may store, in the memory, the minimum font size suitable for display on the first user device.

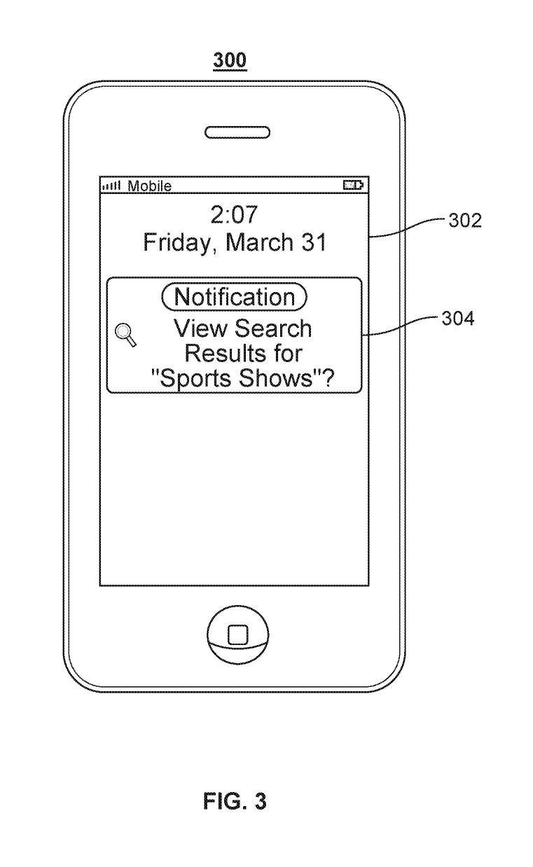

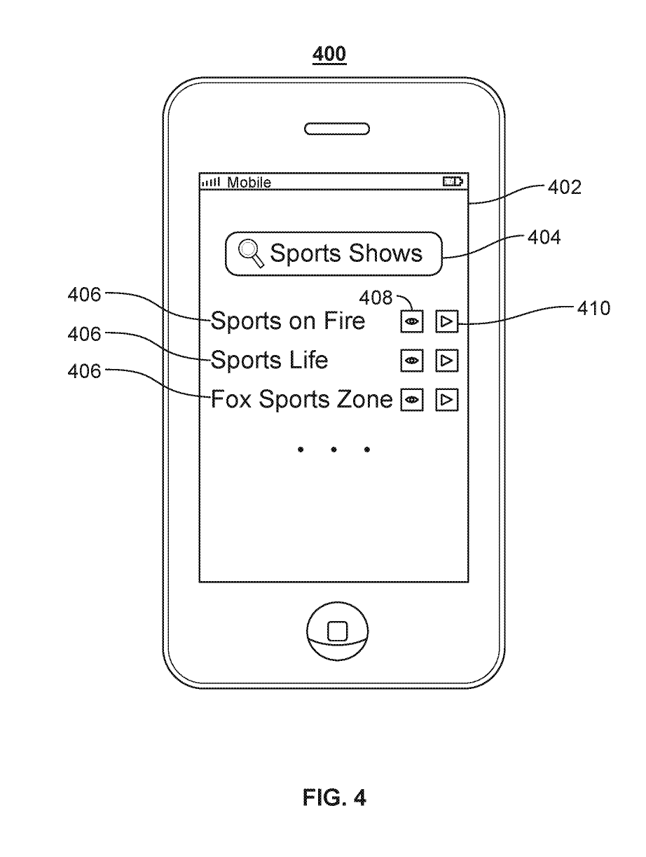

FIGS. 3-4 show illustrative examples 300 and 400 of an interactive media guidance application implemented on a second user device in accordance with some embodiments of the disclosure. The interactive media guidance application may select a second subset of the media assets matching the search query and not included in the first subset. For example, the interactive media guidance application may select the remaining seven media assets from the seven search results that were not included in the first subset. The interactive media guidance application may generate for display the second subset of the media assets, e.g., the seven remaining media assets from the search results, on a second user device, e.g., a mobile phone. For example, the interactive media guidance application may search a network, including the set-top box, for the mobile phone belonging to the user and push the second subset to the mobile phone. Unlike conventional systems, the described systems and methods provide the user with an opportunity to view the search results on a user device more appropriate for viewing a large number of search results. By viewing the search results on his or her mobile phone, the user may find it easier to efficiently navigate the search results using the mobile phone's touchscreen display.

In illustrative example 300, the interactive media guidance application generates for display an indication 304 in lock screen 302 of the first user device. The indication informs the user that search results for the user's search query are available on the second user device. The user may select the indication on the second user device to view the search results. In some embodiments, the interactive media guidance application automatically pushes search results to the second user device without requiring user input. For example, the interactive media guidance application may automatically populate the user's mobile phone screen with the search results following the input of the search query at the user's set-top box.

In illustrative example 300, the interactive media guidance application generates for display the search results 406 for the search query 404 in the display screen 402 of the second user device, e.g., the user's mobile phone. The search results may include some or all of the second subset of the media assets, e.g., the seven remaining media assets from the search results. The interactive media guidance application generates for display options 408 and 410 for each media asset from the search results. In this example, the interactive media guidance application generates an option 408 to add the media asset to a watch list and an option 410 to view the media asset. If the user selects the option to view the media asset on the second user device, e.g., the mobile phone, the interactive media guidance application may generate for display the media asset on the first user device, e.g., the set-top box. Additionally or alternatively, in the instance where the user selects the option to view the media asset on the second user device, e.g., the mobile phone, the interactive media guidance application may generate for display the media asset on the second user device.

In some embodiments, the interactive media guidance application pushes all search results to the second user device, e.g., a mobile phone. Following the example above, the interactive media guidance application may generate for display the selected three media assets on the television display connected to the set-top box and generate for display all 10 search results on the mobile phone. Because the user may find the mobile phone more appropriate for viewing a large number of search results, the user may find it more efficient to view all search results on the mobile phone in this instance.

In some aspects, the systems and methods described enable a user of a user device, e.g., a set-top box, to reduce the number of navigational key presses required in a search screen featuring an on-screen alphanumeric keypad. For example, the user may wish to search for a media asset on his or her set-top box using an associated remote control device. The interactive media guidance application may generate a search screen for “Search by Title,” “Search by Keyword,” or another suitable search screen. The search screen may include an on-screen alphanumeric keypad for the user to enter his or her search query using the remote control device. However, the user may find it difficult to navigate the keypad by repeatedly pressing the directional keys on the remote control device in order to enter even a simple search. For example, the user may have to press several up/left arrow keys to get to “A” after entering “Y.” The interactive media guidance application may push a notification to another user device, e.g., the user's mobile phone, to allow the user to enter his or her search query using the mobile phone and dramatically decrease the text entry duration. In some embodiments, the interactive media guidance application pushes the notification automatically to the user's mobile phone. In some embodiments, the interactive media guidance application pushes the notification to the user's mobile phone when the user depresses a particular button on the remote control device, e.g., the “B” button, when the search screen is displayed.

In some embodiments, the interactive media guidance application generates for display a notification on the lock screen of the user's mobile phone. The interactive media guidance application may prompt the user to enter the search query on the lock screen itself by interacting with the notification. Additionally or alternatively, the interactive media guidance application may allow the user to invoke another user interface on the mobile phone in order to enter his or her search query. This user interface may allow the user remote access to the set-top box as well in order to search, start, or record media assets on the set-top box remotely. After the user enters his or her search query on the mobile phone screen, the interactive media guidance application may generate for display search results for the search query on the set-top box as if the search query were entered using the set-top box's on-screen alphanumeric keypad. As a result, the user may avoid having to repeatedly press the directional or navigational keys for entering his or her or search query and dramatically reduce the duration of the text entry. Additionally, by promoting the user interface on the mobile phone to the user, the user may be better informed about the options to remotely access the set-top box and decide to use this approach in case he or she finds it more beneficial over using the set-top box's on-screen user interface.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a mobile phone, a cellphone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

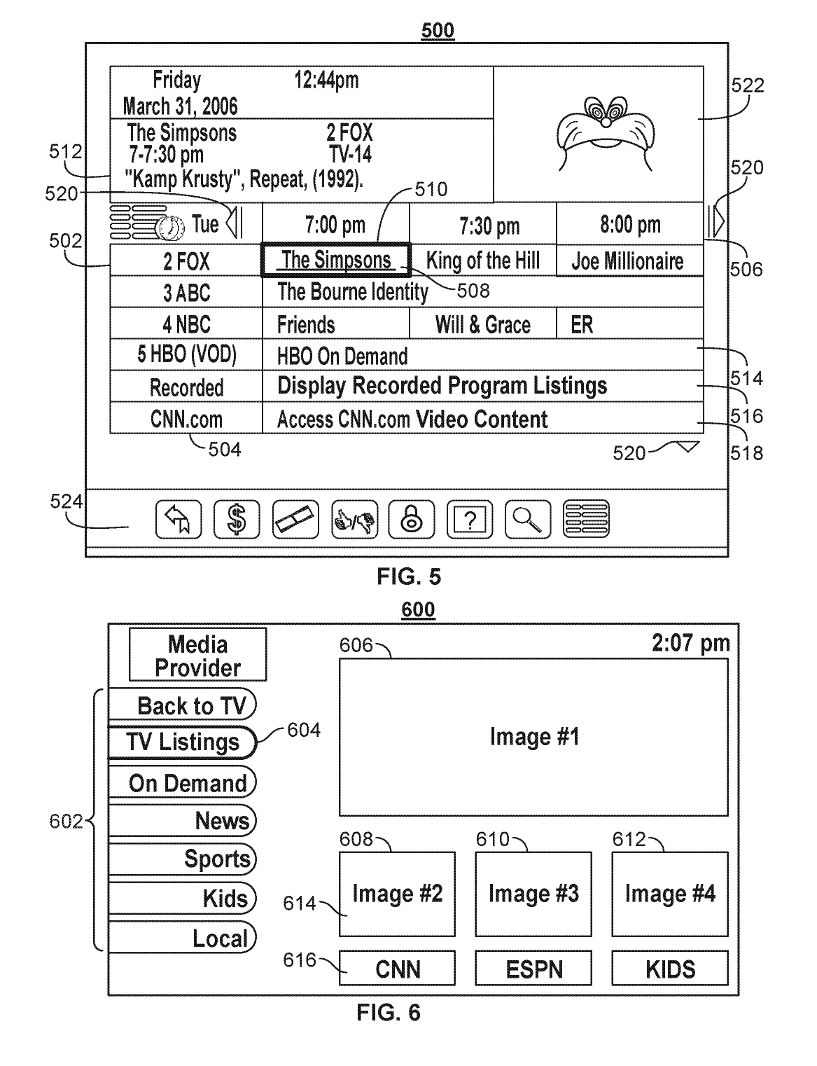

FIGS. 5-6 show illustrative display screens that may be used to provide media guidance data. The display screens shown in FIGS. 5-6 may be implemented on any suitable user equipment device or platform. While the displays of FIGS. 5-6 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 5 shows illustrative grid of a program listings display 500 arranged by time and channel that also enables access to different types of content in a single display. Display 500 may include grid 502 with: (1) a column of channel/content type identifiers 504, where each channel/content type identifier (which is a cell in the column) identifies a different channel or content type available; and (2) a row of time identifiers 506, where each time identifier (which is a cell in the row) identifies a time block of programming. Grid 502 also includes cells of program listings, such as program listing 508, where each listing provides the title of the program provided on the listing's associated channel and time. With a user input device, a user can select program listings by moving highlight region 510. Information relating to the program listing selected by highlight region 510 may be provided in program information region 512. Region 512 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc.

Internet content may include web events, such as a chat session or Webcast, or content available on-demand as streaming content or downloadable content through an Internet web site or other Internet access (e.g., FTP).

Grid 502 may provide media guidance data for non-linear programming including on-demand listing 514, recorded content listing 516, and Internet content listing 518. A display combining media guidance data for content from different types of content sources is sometimes referred to as a “mixed-media” display. Various permutations of the types of media guidance data that may be displayed that are different than display 500 may be based on user selection or guidance application definition (e.g., a display of only recorded and broadcast listings, only on-demand and broadcast listings, etc.). As illustrated, listings 514, 516, and 518 are shown as spanning the entire time block displayed in grid 502 to indicate that selection of these listings may provide access to a display dedicated to on-demand listings, recorded listings, or Internet listings, respectively. In some embodiments, listings for these content types may be included directly in grid 502. Additional media guidance data may be displayed in response to the user selecting one of the navigational icons 520. (Pressing an arrow key on a user input device may affect the display in a similar manner as selecting navigational icons 520.)

Display 500 may also include video region 522, and options region 526. Video region 522 may allow the user to view and/or preview programs that are currently available, will be available, or were available to the user. The content of video region 522 may correspond to, or be independent from, one of the listings displayed in grid 502. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 526 may allow the user to access different types of content, media guidance application displays, and/or media guidance application features. Options region 526 may be part of display 500 (and other display screens described herein), or may be invoked by a user by selecting an on-screen option or pressing a dedicated or assignable button on a user input device. The selectable options within options region 526 may concern features related to program listings in grid 502 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 8. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 6. Video mosaic display 600 includes selectable options 602 for content information organized based on content type, genre, and/or other organization criteria. In display 600, television listings option 604 is selected, thus providing listings 606, 608, 610, and 612 as broadcast program listings. In display 600 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 608 may include more than one portion, including media portion 614 and text portion 616. Media portion 614 and/or text portion 616 may be selectable to view content in full-screen or to view information related to the content displayed in media portion 614 (e.g., to view listings for the channel that the video is displayed on).

The listings in display 600 are of different sizes (i.e., listing 606 is larger than listings 608, 610, and 612), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

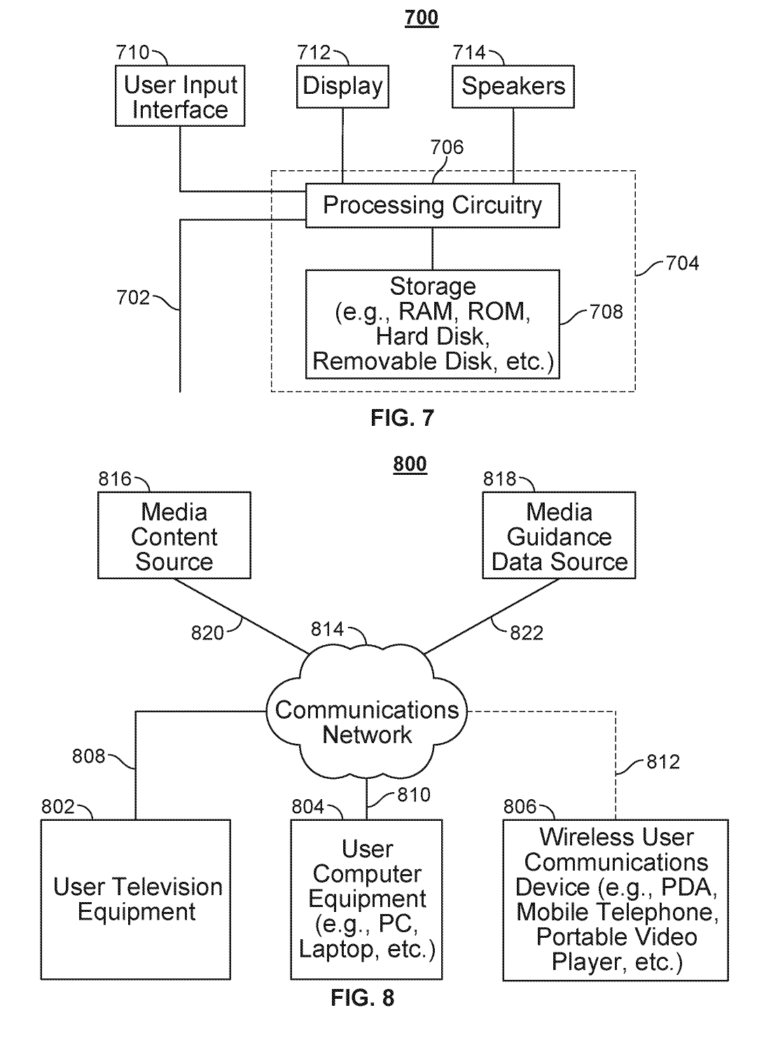

Users may access content and the media guidance application (and its display screens described above and below) from one or more of their user equipment devices. FIG. 7 shows a generalized embodiment of illustrative user equipment device 700. More specific implementations of user equipment devices are discussed below in connection with FIG. 8. User equipment device 700 may receive content and data via input/output (hereinafter “I/O”) path 702. I/O path 702 may provide content (e.g., broadcast programming, on-demand programming, Internet content, content available over a local area network (LAN) or wide area network (WAN), and/or other content) and data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communications paths (described below). I/O functions may be provided by one or more of these communications paths, but are shown as a single path in FIG. 7 to avoid overcomplicating the drawing.

Control circuitry 704 may be based on any suitable processing circuitry such as processing circuitry 706. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for a media guidance application stored in memory (i.e., storage 708). Specifically, control circuitry 704 may be instructed by the media guidance application to perform the functions discussed above and below. For example, the media guidance application may provide instructions to control circuitry 704 to generate the media guidance displays. In some implementations, any action performed by control circuitry 704 may be based on instructions received from the media guidance application.

In client-server based embodiments, control circuitry 704 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 8). In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as media guidance data described above. Nonvolatile memory may also be used (e.g., to launch a boot-up routine and other instructions). Cloud-based storage, described in relation to FIG. 8, may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of the user equipment 700. Circuitry 704 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

A user may send instructions to control circuitry 704 using user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of user equipment device 700. For example, display 712 may be a touchscreen or touch-sensitive display. In such circumstances, user input interface 710 may be integrated with or combined with display 712. Display 712 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 712 may be HDTV-capable. In some embodiments, display 712 may be a 3D display, and the interactive media guidance application and any suitable content may be displayed in 3D. A video card or graphics card may generate the output to the display 712. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 704. The video card may be integrated with the control circuitry 704. Speakers 714 may be provided as integrated with other elements of user equipment device 700 or may be stand-alone units. The audio component of videos and other content displayed on display 712 may be played through speakers 714. In some embodiments, the audio may be distributed to a receiver (not shown), which processes and outputs the audio via speakers 714.

The guidance application may be implemented using any suitable architecture. For example, it may be a stand-alone application wholly-implemented on user equipment device 700. In such an approach, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected.

In some embodiments, the media guidance application is a client-server based application. Data for use by a thick or thin client implemented on user equipment device 700 is retrieved on-demand by issuing requests to a server remote to the user equipment device 700. In one example of a client-server based guidance application, control circuitry 704 runs a web browser that interprets web pages provided by a remote server. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on equipment device 700. This way, the processing of the instructions is performed remotely by the server while the resulting displays are provided locally on equipment device 700. Equipment device 700 may receive inputs from the user via input interface 710 and transmit those inputs to the remote server for processing and generating the corresponding displays. For example, equipment device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to equipment device 700 for presentation to the user.

In some embodiments, the media guidance application is downloaded and interpreted or otherwise run by an interpreter or virtual machine (run by control circuitry 704). In some embodiments, the guidance application may be encoded in the ETV Binary Interchange Format (EBIF), received by control circuitry 704 as part of a suitable feed, and interpreted by a user agent running on control circuitry 704. For example, the guidance application may be an EBIF application. In some embodiments, the guidance application may be defined by a series of JAVA-based files that are received and run by a local virtual machine or other suitable middleware executed by control circuitry 704. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 700 of FIG. 7 can be implemented in system 800 of FIG. 8 as user television equipment 802, user computer equipment 804, wireless user communications device 806, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 7 may not be classified solely as user television equipment 802, user computer equipment 804, or a wireless user communications device 806. For example, user television equipment 802 may, like some user computer equipment 804, be Internet-enabled allowing for access to Internet content, while user computer equipment 804 may, like some television equipment 802, include a tuner allowing for access to television programming. The media guidance application may have the same layout on various different types of user equipment or may be tailored to the display capabilities of the user equipment. For example, on user computer equipment 804, the guidance application may be provided as a web site accessed by a web browser. In another example, the guidance application may be scaled down for wireless user communications devices 806.

In system 800, there is typically more than one of each type of user equipment device but only one of each is shown in FIG. 8 to avoid overcomplicating the drawing. In addition, each user may utilize more than one type of user equipment device and also more than one of each type of user equipment device.

In some embodiments, a user equipment device (e.g., user television equipment 802, user computer equipment 804, wireless user communications device 806) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 814. Namely, user television equipment 802, user computer equipment 804, and wireless user communications device 806 are coupled to communications network 814 via communications paths 808, 810, and 812, respectively. Communications network 814 may be one or more networks including the Internet, a mobile phone network, mobile voice or data network (e.g., a 4G or LTE network), cable network, public switched telephone network, or other types of communications network or combinations of communications networks. Paths 808, 810, and 812 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 812 is drawn with dotted lines to indicate that in the exemplary embodiment shown in FIG. 8 it is a wireless path and paths 808 and 810 are drawn as solid lines to indicate they are wired paths (although these paths may be wireless paths, if desired). Communications with the user equipment devices may be provided by one or more of these communications paths, but are shown as a single path in FIG. 8 to avoid overcomplicating the drawing.

Although communications paths are not drawn between user equipment devices, these devices may communicate directly with each other via communication paths, such as those described above in connection with paths 808, 810, and 812, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 814.

System 800 includes content source 816 and media guidance data source 818 coupled to communications network 814 via communication paths 820 and 822, respectively. Paths 820 and 822 may include any of the communication paths described above in connection with paths 808, 810, and 812. Communications with the content source 816 and media guidance data source 818 may be exchanged over one or more communications paths, but are shown as a single path in FIG. 8 to avoid overcomplicating the drawing. In addition, there may be more than one of each of content source 816 and media guidance data source 818, but only one of each is shown in FIG. 8 to avoid overcomplicating the drawing. (The different types of each of these sources are discussed below.) If desired, content source 816 and media guidance data source 818 may be integrated as one source device. Although communications between sources 816 and 818 with user equipment devices 802, 804, and 806 are shown as through communications network 814, in some embodiments, sources 816 and 818 may communicate directly with user equipment devices 802, 804, and 806 via communication paths (not shown) such as those described above in connection with paths 808, 810, and 812.

Content source 816 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 816 may be the originator of content (e.g., a television broadcaster, a Webcast provider, etc.) or may not be the originator of content (e.g., an on-demand content provider, an Internet provider of content of broadcast programs for downloading, etc.). Content source 816 may include cable sources, satellite providers, on-demand providers, Internet providers, over-the-top content providers, or other providers of content. Content source 816 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 818 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 818 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 818 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 818 may provide user equipment devices 802, 804, and 806 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 708, and executed by control circuitry 704 of a user equipment device 700. In some embodiments, media guidance applications may be client-server applications where only a client application resides on the user equipment device, and server application resides on a remote server. For example, media guidance applications may be implemented partially as a client application on control circuitry 704 of user equipment device 700 and partially on a remote server as a server application (e.g., media guidance data source 818) running on control circuitry of the remote server. When executed by control circuitry of the remote server (such as media guidance data source 818), the media guidance application may instruct the control circuitry to generate the guidance application displays and transmit the generated displays to the user equipment devices. The server application may instruct the control circuitry of the media guidance data source 818 to transmit data for storage on the user equipment. The client application may instruct control circuitry of the receiving user equipment to generate the guidance application displays.

Content and/or media guidance data delivered to user equipment devices 802, 804, and 806 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 800 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 8.

In one approach, user equipment devices may communicate with each other within a home network. User equipment devices can communicate with each other directly via short-range point-to-point communication schemes described above, via indirect paths through a hub or other similar device provided on a home network, or via communications network 814. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a web site via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 816 to access content. Specifically, within a home, users of user television equipment 802 and user computer equipment 804 may access the media guidance application to navigate among and locate desirable content. Users may also access the media guidance application outside of the home using wireless user communications devices 806 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 814. These cloud resources may include one or more content sources 816 and one or more media guidance data sources 818. In addition or in the alternative, the remote computing sites may include other user equipment devices, such as user television equipment 802, user computer equipment 804, and wireless user communications device 806. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 804 or wireless user communications device 806 having content capture feature. Alternatively, the user can first transfer the content to a user equipment device, such as user computer equipment 804. The user equipment device storing the content uploads the content to the cloud using a data transmission service on communications network 814. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 7.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

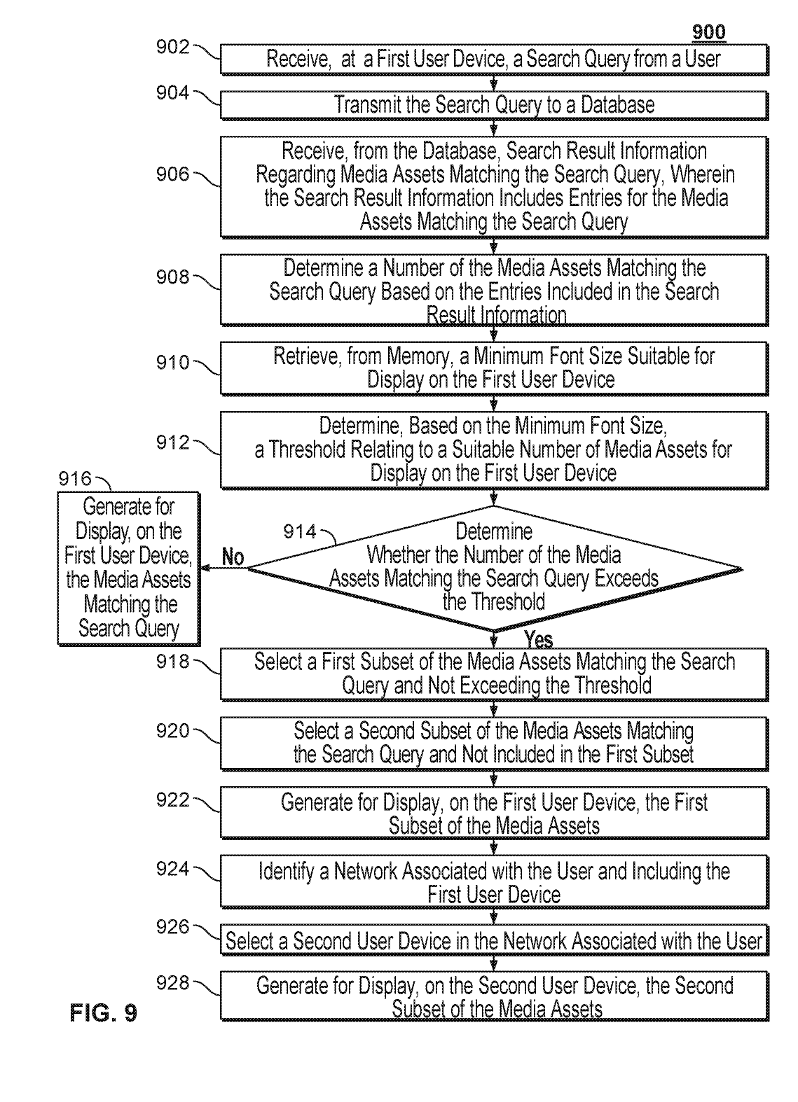

FIG. 9 is a flowchart of illustrative process 900 for an interactive media guidance application implemented on control circuitry (e.g., control circuitry 704, FIG. 7) of a user device (e.g., user equipment device 700, FIG. 7) to determine one or more user devices (e.g., user television equipment 802, user computer equipment 804, or wireless user communications device 806, FIG. 8), suitable for display media assets matching a search query in accordance with some embodiments of the disclosure. In some embodiments, these algorithms may be encoded onto a non-transitory storage medium (e.g., storage device 708) as a set of instructions to be decoded and executed by processing circuitry (e.g., processing circuitry 706). Processing circuitry may in turn provide instructions to other sub-circuits contained within control circuitry 704, such as the tuning, video generating, encoding, decoding, encrypting, decrypting, scaling, analog/digital conversion circuitry, and the like.

At step 902, the interactive media guidance application implemented on control circuitry (e.g., control circuitry 704, FIG. 7) receives, at a first user device, a search query from a user. For example, the interactive media guidance application may receive a search query from a user, e.g., “sports shows,” at a first user device, e.g., a set-top box.

At step 904, the interactive media guidance application implemented on control circuitry (e.g., control circuitry 704, FIG. 7) transmits the search query to a database, e.g., media content source 816 (FIG. 8), media guidance data source 818 (FIG. 8), or another suitable database.

At step 906, the interactive media guidance application implemented on control circuitry (e.g., control circuitry 704, FIG. 7) receives, from the database, search result information regarding media assets matching the search query. The search result information includes entries for the media assets matching the search query. For example, the interactive media guidance application may receive search result information including 50 entries for media assets matching the search query.

At step 908, the interactive media guidance application implemented on control circuitry (e.g., control circuitry 704, FIG. 7) determines a number of the media assets matching the search query based on the entries included in the search result information. For example, the interactive media guidance application may determine that the 50 media assets match the search query based on the 50 entries included in the search result information.

At step 910, the interactive media guidance application implemented on control circuitry (e.g., control circuitry 704, FIG. 7) retrieves, from memory (e.g., storage 708, FIG. 7), a minimum font size suitable for display on the first user device. For example, the interactive media guidance application may retrieve from the memory a minimum font size of 28 point as being suitable for displaying search results on the first user device.

In some embodiments, the interactive media guidance application receives a display resolution associated with the first user device, e.g., display 712 of user equipment device 700 (FIG. 7). The interactive media guidance application determines the minimum font size based on the display resolution associated with the first user device. For example, the television display connected to the set-top box may have a display resolution of 1920×1080 pixels. The interactive media guidance application may determine the minimum font size based on the display resolution associated with the first user device. The interactive media guidance application may retrieve a reference display resolution, e.g., 1366×768 pixels, and a reference font size, e.g., 20 point. The interactive media guidance application may calculate a ratio of the user's display resolution and the reference display resolution, e.g., 1.4. The interactive media guidance application may adjust the reference font size proportional to the ratio to determine the minimum font size for the first user device, e.g., 28 point. The interactive media guidance application stores, in the memory, the minimum font size suitable for display on the first user device.

At step 912, the interactive media guidance application implemented on control circuitry (e.g., control circuitry 704, FIG. 7) determines, based on the minimum font size, a threshold relating to a suitable number of media assets for display on the first user device. For example, the interactive media guidance application may determine that 10 media assets may fit in a single screen when displayed at the minimum font size, 28 point. The interactive media guidance application may select the threshold to be 10 media assets so that the user need not scroll through multiple screens to view the search results.

At step 914, the interactive media guidance application implemented on control circuitry (e.g., control circuitry 704, FIG. 7) determines whether the number of the media assets matching the search query exceeds the threshold. For example, the interactive media guidance application may determine whether the 50 media assets from the search results exceed the threshold of 10 media assets.

At step 916, based on determining that the number of the media assets matching the search query does not exceed the threshold, the interactive media guidance application implemented on control circuitry (e.g., control circuitry 704, FIG. 7) generates for display, on the first user device, the media assets matching the search query. For example, if the media assets from the search results do not exceed 10 media assets, the interactive media guidance application may generate for display the media assets on the first user device only.

At step 918, based on determining that the number of the media assets matching the search query exceeds the threshold, the interactive media guidance application implemented on control circuitry (e.g., control circuitry 704, FIG. 7) selects a first subset of the media assets matching the search query and not exceeding the threshold. For example, the interactive media guidance application may determine that the 50 media assets from the search results exceed the threshold of 10 media assets. The interactive media guidance application may select 10 media assets from the search results to include in the first subset.

In some embodiments, the interactive media guidance application selects the first subset of the media assets matching the search query and not exceeding the threshold by ranking the media assets matching the search query based on the user's profile and selecting the first subset based on the ranking of the media assets matching the search query. The interactive media guidance application may retrieve the user's profile from memory and calculate an affinity score for each media asset from the search results with respect to the profile. For example, the interactive media guidance application may calculate a score from 0 to 10 where 0 means no affinity with respect to the user's profile and 10 means very high affinity with respect to the user's profile. For example, if the user's profile indicates the user prefers comedy shows above all other media, the interactive media guidance application may calculate an affinity score close to 10 for a media asset that is a comedy show. The interactive media guidance application may sort the media assets from the search results according to their respective affinity scores. If the threshold is 10 media assets, the interactive media guidance application may select the top 10 media assets from 50 media assets in the search results for display on the first user device.

At step 920, the interactive media guidance application implemented on control circuitry (e.g., control circuitry 704, FIG. 7) selects a second subset of the media assets matching the search query and not included in the first subset. For example, the interactive media guidance application may select the remaining 40 media assets from the search results that were not included in the first subset.

At step 922, the interactive media guidance application implemented on control circuitry (e.g., control circuitry 704, FIG. 7) generates for display, on the first user device, the first subset of the media assets. For example, the interactive media guidance application may generate for display the selected 10 media assets from the first subset on the first user device, e.g., the set-top box.

In some embodiments, the interactive media guidance application generates for display, on the first user device, the first subset of the media assets by generating for display, on the first user device, the first subset of the media assets in the minimum font size. For example, the interactive media guidance application generates for display the first subset of the media assets in the minimum font size of 28 point. Alternatively or additionally, the interactive media guidance application may generate some or all of the media assets in a bigger font. For example, if there is fewer than the threshold number of media assets to be displayed, the interactive media guidance application may select a higher font size than the minimum font size to generate for display the media assets.

At step 924, the interactive media guidance application implemented on control circuitry (e.g., control circuitry 704, FIG. 7) identifies a network associated with the user and including the first user device. For example, the interactive media guidance application may identify a wireless network associated with the user and including the first user device, e.g., the set-top box.

At step 926, the interactive media guidance application implemented on control circuitry (e.g., control circuitry 704, FIG. 7) selects a second user device in the network associated with the user. For example, the interactive media guidance application may select a mobile phone that is in the network and associated with the user.

At step 928, the interactive media guidance application implemented on control circuitry (e.g., control circuitry 704, FIG. 7) generates for display, on the second user device, the second subset of the media assets. For example, the interactive media guidance application may generate for display the second subset of the media assets, e.g., the 40 remaining media assets from the search results, on the second user device, e.g., a mobile phone.

In some embodiments, the interactive media guidance application generates for display, on at least one of the first user device and the second user device, an indication that the number of the media assets matching the search query exceeds the threshold. For example, the indication may inform the user that additional search results, beyond the threshold number displayed on the first user device, are available on the second user device. Additionally or alternatively, the interactive media guidance application may generate for display an indication on the second user device. The indication may inform the user that search results for the user's search query are available for display on the second user device.

In some embodiments, the interactive media guidance application receives, at the at least one of the first user device and the second user device, a user selection of the indication. The second subset of the media assets is generated for display on the second user device based on receiving the user selection of the indication. For example, the user may select the indication on the second user device to view the search results.

In some embodiments, the second subset of the media assets is automatically generated for display on the second user device subsequent to the indication being generated for display on the at least one of the first user device and the second user device. For example, the interactive media guidance application may automatically push search results to the second user device without requiring user input. The interactive media guidance application may automatically populate the user's mobile phone screen with the search results following the input of the search query at the user's set-top box.

In some embodiments, the interactive media guidance application receives, at the first user device, a selection of a media asset from the first subset of the media assets. The interactive media guidance application generates for display, on the first user device, the selected media asset. For example, in the instance where the user selects the option to view the media asset on the first user device, e.g., the set-top box, the interactive media guidance application may generate for display the media asset on the first user device.

In some embodiments, the interactive media guidance application receives, at the second user device, a selection of a media asset from the second subset of the media assets. The interactive media guidance application generates for display, on the first user device, the selected media asset. For example, in the instance where the user selects the option to view the media asset on the second user device, e.g., the mobile phone, the interactive media guidance application may generate for display the media asset on the first user device, e.g., the set-top box.

It is contemplated that the steps or descriptions of FIG. 9 may be used with any other embodiment of this disclosure. In addition, the descriptions described in relation to the algorithm of FIG. 9 may be done in alternative orders or in parallel to further the purposes of this disclosure. For example, in some embodiments, several instances of a variable may be evaluated in parallel, using multiple logical processor threads, or the algorithm may be enhanced by incorporating branch prediction. Furthermore, it should be noted that the process of FIG. 9 may be implemented on a combination of appropriately configured software and hardware, and that any of the devices or equipment discussed in relation to FIGS. 7-8 could be used to implement one or more portions of the process.

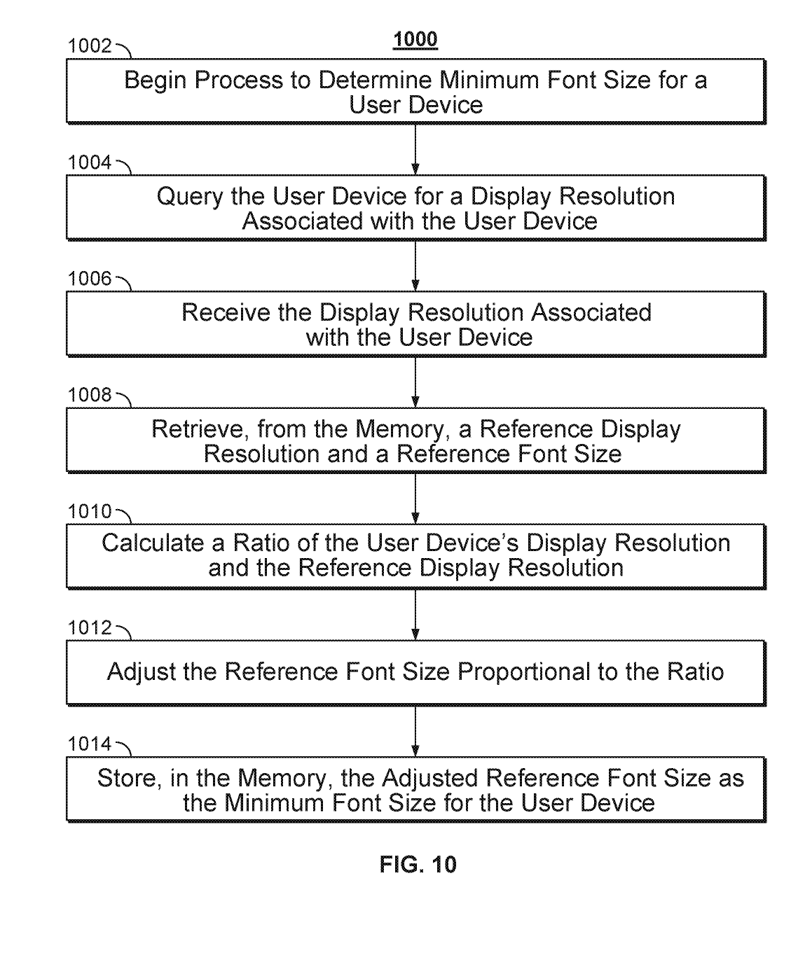

FIG. 10 is a flowchart of illustrative process 1000 for an interactive media guidance application implemented on control circuitry (e.g., control circuitry 704, FIG. 7) of a user device (e.g., user equipment device 700, FIG. 7) to determine a minimum font size for a user device in accordance with some embodiments of the disclosure. In some embodiments, these algorithms may be encoded onto a non-transitory storage medium (e.g., storage device 708) as a set of instructions to be decoded and executed by processing circuitry (e.g., processing circuitry 706). Processing circuitry may in turn provide instructions to other sub-circuits contained within control circuitry 704, such as the tuning, video generating, encoding, decoding, encrypting, decrypting, scaling, analog/digital conversion circuitry, and the like.

At step 1002, the interactive media guidance application implemented on control circuitry (e.g., control circuitry 704, FIG. 7) initiates the process for determining a minimum font size for a user device. In some embodiments, this may be done either directly or indirectly in response to a user action or input (e.g., from signals received by control circuitry 704 or user input interface 710). For example, the process may begin directly in response to control circuitry 704 receiving signals from user input interface 710, or control circuitry 704 may prompt the user to confirm their input using a display (e.g., by generating a prompt to be displayed on display 712) prior to running the algorithm.

At step 1004, the interactive media guidance application implemented on control circuitry (e.g., control circuitry 704, FIG. 7) queries the user device for a display resolution associated with the user device. For example, the interactive media guidance application may query a set-top box associated with the user for a display resolution associated with the set-top box.

At step 1006, the interactive media guidance application implemented on control circuitry (e.g., control circuitry 704, FIG. 7) receives the display resolution associated with the user device. The interactive media guidance application determines the minimum font size based on the display resolution associated with the user device. For example, the television display connected to the set-top box may have a display resolution of 1920×1080 pixels. The interactive media guidance application may determine the minimum font size based on the display resolution associated with the user device.

At step 1008, the interactive media guidance application implemented on control circuitry (e.g., control circuitry 704, FIG. 7) retrieves from the memory a reference display resolution, e.g., 1366×768 pixels, and a reference font size, e.g., 20 point.

At step 1010, the interactive media guidance application implemented on control circuitry (e.g., control circuitry 704, FIG. 7) calculates a ratio of the user's display resolution and the reference display resolution, e.g., 1.4.

At step 1012, the interactive media guidance application implemented on control circuitry (e.g., control circuitry 704, FIG. 7) adjusts the reference font size proportional to the ratio to determine the minimum font size for the user device, e.g., 28 point.

At step 1014, the interactive media guidance application implemented on control circuitry (e.g., control circuitry 704, FIG. 7) stores, in the memory, the adjusted reference font size as the minimum font size suitable for display on the user device.

It is contemplated that the steps or descriptions of FIG. 10 may be used with any other embodiment of this disclosure. In addition, the descriptions described in relation to the algorithm of FIG. 10 may be done in alternative orders or in parallel to further the purposes of this disclosure. For example, in some embodiments, several instances of a variable may be evaluated in parallel, using multiple logical processor threads, or the algorithm may be enhanced by incorporating branch prediction. Furthermore, it should be noted that the process of FIG. 10 may be implemented on a combination of appropriately configured software and hardware, and that any of the devices or equipment discussed in relation to FIGS. 7-8 could be used to implement one or more portions of the process.

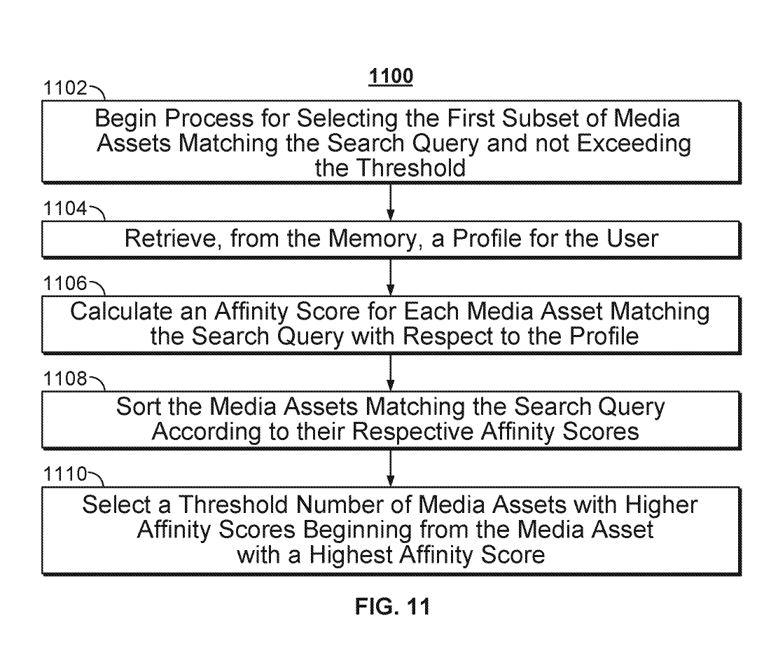

FIG. 11 is a flowchart of illustrative process 1100 for an interactive media guidance application implemented on control circuitry (e.g., control circuitry 704, FIG. 7) of a user device (e.g., user equipment device 700, FIG. 7) to select the first subset of the media assets matching the search query and not exceeding the threshold input in accordance with some embodiments of the disclosure. Process 1100 provides an illustrative process for executing step 906 (FIG. 9) or step 1006 (FIG. 10). In some embodiments, this algorithm may be encoded onto a non-transitory storage medium (e.g., storage device 708) as a set of instructions to be decoded and executed by processing circuitry (e.g., processing circuitry 706). Processing circuitry may in turn provide instructions to other sub-circuits contained within control circuitry 704, such as the tuning, video generating, encoding, decoding, encrypting, decrypting, scaling, analog/digital conversion circuitry, and the like.

At step 1102, the interactive media guidance application implemented on control circuitry (e.g., control circuitry 704, FIG. 7) initiates the process for selecting the first subset of the media assets matching the search query and not exceeding the threshold. In some embodiments, this may be done either directly or indirectly in response to a user action or input (e.g., from signals received by control circuitry 704 or user input interface 710). For example, the process may begin directly in response to control circuitry 704 receiving signals from user input interface 710, or control circuitry 704 may prompt the user to confirm their input using a display (e.g., by generating a prompt to be displayed on display 712) prior to running the algorithm.

At step 1104, the interactive media guidance application implemented on control circuitry (e.g., control circuitry 704, FIG. 7) retrieves the user's profile from memory. For example, the user's profile may indicate that the user prefers comedy shows above all other media.

At step 1106, the interactive media guidance application implemented on control circuitry (e.g., control circuitry 704, FIG. 7) calculates an affinity score for each media asset matching the search query with respect to the profile. For example, the interactive media guidance application may calculate a score from 0 to 10 where 0 means no affinity with respect to the user's profile and 10 means very high affinity with respect to the user's profile. For example, if the user's profile indicates the user prefers comedy shows above all other media, the interactive media guidance application may calculate an affinity score close to 10 for a media asset that is a comedy show.

At step 1108, the interactive media guidance application implemented on control circuitry (e.g., control circuitry 704, FIG. 7) sorts the media assets from the search results according to their respective affinity scores. For example, the interactive media guidance application may sort the media assets from highest to lowest affinity score.

At step 1110, the interactive media guidance application implemented on control circuitry (e.g., control circuitry 704, FIG. 7) selects a threshold number of media assets with higher affinity scores beginning from the media asset with a highest affinity score. For example, in the instance where the threshold is 10 media assets, the interactive media guidance application may select the 10 media assets with the highest affinity scores from the 50 media assets in the search results.

It is contemplated that the steps or descriptions of FIG. 11 may be used with any other embodiment of this disclosure. In addition, the descriptions described in relation to the algorithm of FIG. 11 may be done in alternative orders or in parallel to further the purposes of this disclosure. For example, in some embodiments, several instances of a variable may be evaluated in parallel, using multiple logical processor threads, or the algorithm may be enhanced by incorporating branch prediction. Furthermore, it should be noted that the process of FIG. 11 may be implemented on a combination of appropriately configured software and hardware, and that any of the devices or equipment discussed in relation to FIGS. 7-8 could be used to implement one or more portions of the process.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method for determining one or more user devices suitable for displaying media assets matching a search query, comprising:
receiving, at a first user device, a search query from a user;
searching for media assets matching the search query;
determining whether a number of the media assets matching the search query exceeds a threshold;
based on determining that the number of the media assets matching the search query exceeds the threshold:
selecting a first subset of the media assets matching the search query and not exceeding the threshold;
selecting a second subset of the media assets matching the search query and not included in the first subset;
generating for display, on the first user device, the first subset of the media assets;
generating for display, on a second user device, the second subset of the media assets.

2. A method for determining one or more user devices suitable for displaying media assets matching a search query, comprising:
receiving, at a first user device, a search query from a user;
transmitting the search query to a database;
receiving, from the database, search result information regarding media assets matching the search query, wherein the search result information includes entries for the media assets matching the search query;
determining a number of the media assets matching the search query based on the entries included in the search result information;
retrieving, from memory, a minimum font size suitable for display on the first user device;
determining, based on the minimum font size, a threshold relating to a suitable number of media assets for display on the first user device;
determining whether the number of the media assets matching the search query exceeds the threshold;
based on determining that the number of the media assets matching the search query exceeds the threshold:
selecting a first subset of the media assets matching the search query and not exceeding the threshold;
selecting a second subset of the media assets matching the search query and not included in the first subset;
generating for display, on the first user device, the first subset of the media assets;
identifying a network associated with the user and including the first user device;
selecting a second user device in the network associated with the user;
generating for display, on the second user device, the second subset of the media assets.

3. The method of claim 2, wherein selecting the first subset of the media assets matching the search query and not exceeding the threshold comprises:
ranking the media assets matching the search query based on the user's profile;
selecting the first subset based on the ranking of the media assets matching the search query.

4. The method of claim 2, wherein generating for display, on the first user device, the first subset of the media assets comprises generating for display, on the first user device, the first subset of the media assets in the minimum font size.

5. The method of claim 2, further comprising:
receiving a display resolution associated with the first user device;
determining the minimum font size based on the display resolution associated with the first user device;
storing, in the memory, the minimum font size suitable for display on the first user device.

6. The method of claim 2, further comprising:
generating for display, on at least one of the first user device and the second user device, an indication that the number of the media assets matching the search query exceeds the threshold.

7. The method of claim 6, further comprising:
receiving, at the at least one of the first user device and the second user device, a user selection of the indication, wherein the second subset of the media assets is generated for display on the second user device based on receiving the user selection of the indication.

8. The method of claim 6, wherein the second subset of the media assets is automatically generated for display on the second user device subsequent to the indication being generated for display on the at least one of the first user device and the second user device.

9. The method of claim 2, further comprising:
based on determining that the number of the media assets matching the search query does not exceed the threshold, generating for display, on the first user device, the media assets matching the search query.

10. The method of claim 2, further comprising:
receiving, at the first user device, a selection of a media asset from the first subset of the media assets;
generating for display, on the first user device, the selected media asset.

11. The method of claim 2, further comprising:
receiving, at the second user device, a selection of a media asset from the second subset of the media assets;
generating for display, on the first user device, the selected media asset.

12. A system for determining one or more user devices suitable for displaying media assets matching a search query, comprising:
a first user device;
a second user device;
a memory;
control circuitry configured to:
receive, at the first user device, a search query from a user;
transmit the search query to a database;
receive, from the database, search result information regarding media assets matching the search query, wherein the search result information includes entries for the media assets matching the search query;
determine a number of the media assets matching the search query based on the entries included in the search result information;
retrieve, from the memory, a minimum font size suitable for display on the first user device;
determine, based on the minimum font size, a threshold relating to a suitable number of media assets for display on the first user device;
determine whether the number of the media assets matching the search query exceeds the threshold;
based on determining that the number of the media assets matching the search query exceeds the threshold:
select a first subset of the media assets matching the search query and not exceeding the threshold;
select a second subset of the media assets matching the search query and not included in the first subset;
generate for display, on the first user device, the first subset of the media assets;
identify the network associated with the user and including the first user device;
select the second user device in a network associated with the user;
generate for display, on the second user device, the second subset of the media assets.

13. The system of claim 12, wherein the control circuitry configured to select the first subset of the media assets matching the search query and not exceeding the threshold comprises control circuitry configured to:
rank the media assets matching the search query based on the user's profile;
select the first subset based on the ranking of the media assets matching the search query.

14. The system of claim 12, wherein the control circuitry configured to generate for display, on the first user device, the first subset of the media assets comprises control circuitry configured to generate for display, on the first user device, the first subset of the media assets in the minimum font size.

15. The system of claim 12, wherein the control circuitry is further configured to:
receive a display resolution associated with the first user device;
determine the minimum font size based on the display resolution associated with the first user device;
store, in the memory, the minimum font size suitable for display on the first user device.

16. The system of claim 12, wherein the control circuitry is further configured to:
generate for display, on at least one of the first user device and the second user device, an indication that the number of the media assets matching the search query exceeds the threshold.

17. The system of claim 16, wherein the control circuitry is further configured to:
receive, at the at least one of the first user device and the second user device, a user selection of the indication, wherein the second subset of the media assets is generated for display on the second user device based on receiving the user selection of the indication.

18. The system of claim 16, wherein the second subset of the media assets is automatically generated for display on the second user device subsequent to the indication being generated for display on the at least one of the first user device and the second user device.

19. The system of claim 12, wherein the control circuitry is further configured to:
based on determining that the number of the media assets matching the search query does not exceed the threshold, generate for display, on the first user device, the media assets matching the search query.

20. The system of claim 12, wherein the control circuitry is further configured to:
receive, at the first user device, a selection of a media asset from the first subset of the media assets;
generate for display, on the first user device, the selected media asset.

21. The system of claim 12, wherein the control circuitry is further configured to:
receive, at the second user device, a selection of a media asset from the second subset of the media assets;
generate for display, on the first user device, the selected media asset.

22. An apparatus for determining one or more user devices suitable for displaying media assets matching a search query, comprising:
means for receiving, at a first user device, a search query from a user;
means for transmitting the search query to a database;
means for receiving, from the database, search result information regarding media assets matching the search query, wherein the search result information includes entries for the media assets matching the search query;
means for determining a number of the media assets matching the search query based on the entries included in the search result information;
means for retrieving, from memory, a minimum font size suitable for display on the first user device;
means for determining, based on the minimum font size, a threshold relating to a suitable number of media assets for display on the first user device;
means for determining whether the number of the media assets matching the search query exceeds the threshold;
based on determining that the number of the media assets matching the search query exceeds the threshold:
means for selecting a first subset of the media assets matching the search query and not exceeding the threshold;
means for selecting a second subset of the media assets matching the search query and not included in the first subset;
means for generating for display, on the first user device, the first subset of the media assets;
means for identifying a network associated with the user and including the first user device;
means for selecting a second user device in the network associated with the user;
means for generating for display, on the second user device, the second subset of the media assets.

23. The apparatus of claim 22, wherein the means for selecting the first subset of the media assets matching the search query and not exceeding the threshold comprises:
means for ranking the media assets matching the search query based on the user's profile;
means for selecting the first subset based on the ranking of the media assets matching the search query.

24. The apparatus of claim 22, wherein the means for generating for display, on the first user device, the first subset of the media assets comprises means for generating for display, on the first user device, the first subset of the media assets in the minimum font size.

25. The apparatus of claim 22, further comprising:
means for receiving a display resolution associated with the first user device;
means for determining the minimum font size based on the display resolution associated with the first user device;
means for storing, in the memory, the minimum font size suitable for display on the first user device.

26. The apparatus of claim 22, further comprising:
means for generating for display, on at least one of the first user device and the second user device, an indication that the number of the media assets matching the search query exceeds the threshold.

27. The apparatus of claim 26, further comprising:
means for receiving, at the at least one of the first user device and the second user device, a user selection of the indication, wherein the second subset of the media assets is generated for display on the second user device based on receiving the user selection of the indication.

28. The apparatus of claim 26, wherein the second subset of the media assets is automatically generated for display on the second user device subsequent to the indication being generated for display on the at least one of the first user device and the second user device.

29. The apparatus of claim 22, further comprising:
based on determining that the number of the media assets matching the search query does not exceed the threshold, means for generating for display, on the first user device, the media assets matching the search query.

30. The apparatus of claim 22, further comprising:
means for receiving, at the first user device, a selection of a media asset from the first subset of the media assets;
means for generating for display, on the first user device, the selected media asset.

31. The apparatus of claim 22, further comprising:
means for receiving, at the second user device, a selection of a media asset from the second subset of the media assets;
means for generating for display, on the first user device, the selected media asset.

32. A non-transitory machine-readable medium comprising memory with instructions encoded thereon for determining one or more user devices suitable for displaying media assets matching a search query, comprising:
instructions for receiving, at a first user device, a search query from a user;
instructions for transmitting the search query to a database;
instructions for receiving, from the database, search result information regarding media assets matching the search query, wherein the search result information includes entries for the media assets matching the search query;
instructions for determining a number of the media assets matching the search query based on the entries included in the search result information;
instructions for retrieving, from memory, a minimum font size suitable for display on the first user device;
instructions for determining, based on the minimum font size, a threshold relating to a suitable number of media assets for display on the first user device;
instructions for determining whether the number of the media assets matching the search query exceeds the threshold;
based on determining that the number of the media assets matching the search query exceeds the threshold:
instructions for selecting a first subset of the media assets matching the search query and not exceeding the threshold;
instructions for selecting a second subset of the media assets matching the search query and not included in the first subset;
instructions for generating for display, on the first user device, the first subset of the media assets;
instructions for identifying a network associated with the user and including the first user device;
instructions for selecting a second user device in the network associated with the user;
instructions for generating for display, on the second user device, the second subset of the media assets.

33. The non-transitory machine-readable medium of claim 32, wherein the instructions for selecting the first subset of the media assets matching the search query and not exceeding the threshold comprises:
instructions for ranking the media assets matching the search query based on the user's profile;
instructions for selecting the first subset based on the ranking of the media assets matching the search query.

34. The non-transitory machine-readable medium of claim 32, wherein the instructions for generating for display, on the first user device, the first subset of the media assets comprises instructions for generating for display, on the first user device, the first subset of the media assets in the minimum font size.

35. The non-transitory machine-readable medium of claim 32, further comprising:
instructions for receiving a display resolution associated with the first user device;
instructions for determining the minimum font size based on the display resolution associated with the first user device;
instructions for storing, in the memory, the minimum font size suitable for display on the first user device.

36. The non-transitory machine-readable medium of claim 32, further comprising:
instructions for generating for display, on at least one of the first user device and the second user device, an indication that the number of the media assets matching the search query exceeds the threshold.

37. The non-transitory machine-readable medium of claim 36, further comprising:
instructions for receiving, at the at least one of the first user device and the second user device, a user selection of the indication, wherein the second subset of the media assets is generated for display on the second user device based on receiving the user selection of the indication.

38. The non-transitory machine-readable medium of claim 36, wherein the second subset of the media assets is automatically generated for display on the second user device subsequent to the indication being generated for display on the at least one of the first user device and the second user device.

39. The non-transitory machine-readable medium of claim 32, further comprising:
based on determining that the number of the media assets matching the search query does not exceed the threshold, instructions for generating for display, on the first user device, the media assets matching the search query.

40. The non-transitory machine-readable medium of claim 32, further comprising:
instructions for receiving, at the first user device, a selection of a media asset from the first subset of the media assets;
instructions for generating for display, on the first user device, the selected media asset.

41. The non-transitory machine-readable medium of claim 32, further comprising:
instructions for receiving, at the second user device, a selection of a media asset from the second subset of the media assets;
instructions for generating for display, on the first user device, the selected media asset.

42. A method for determining one or more user devices suitable for displaying media assets matching a search query, comprising:
receiving, at a first user device, a search query from a user;
transmitting the search query to a database;
receiving, from the database, search result information regarding media assets matching the search query, wherein the search result information includes entries for the media assets matching the search query;
determining a number of the media assets matching the search query based on the entries included in the search result information;
retrieving, from memory, a minimum font size suitable for display on the first user device;
determining, based on the minimum font size, a threshold relating to a suitable number of media assets for display on the first user device;
determining whether the number of the media assets matching the search query exceeds the threshold;
based on determining that the number of the media assets matching the search query exceeds the threshold:
selecting a first subset of the media assets matching the search query and not exceeding the threshold;
selecting a second subset of the media assets matching the search query and not included in the first subset;
generating for display, on the first user device, the first subset of the media assets;
identifying a network associated with the user and including the first user device;
selecting a second user device in the network associated with the user;
generating for display, on the second user device, the second subset of the media assets.

43. The method of claim 42, wherein selecting the first subset of the media assets matching the search query and not exceeding the threshold comprises:
ranking the media assets matching the search query based on the user's profile;
selecting the first subset based on the ranking of the media assets matching the search query.

44. The method of claim 42 or 43, wherein generating for display, on the first user device, the first subset of the media assets comprises generating for display, on the first user device, the first subset of the media assets in the minimum font size.

45. The method of any one of claims 42-44, further comprising:
receiving a display resolution associated with the first user device;
determining the minimum font size based on the display resolution associated with the first user device;
storing, in the memory, the minimum font size suitable for display on the first user device.

46. The method of any one of claims 42-45, further comprising:
generating for display, on at least one of the first user device and the second user device, an indication that the number of the media assets matching the search query exceeds the threshold.

47. The method of claim 46, further comprising:
receiving, at the at least one of the first user device and the second user device, a user selection of the indication, wherein the second subset of the media assets is generated for display on the second user device based on receiving the user selection of the indication.

48. The method of claim 46, wherein the second subset of the media assets is automatically generated for display on the second user device subsequent to the indication being generated for display on the at least one of the first user device and the second user device.

49. The method of any one of claims 42-48, further comprising:
based on determining that the number of the media assets matching the search query does not exceed the threshold, generating for display, on the first user device, the media assets matching the search query.

50. The method of any one of claims 42-49, further comprising:
receiving, at the first user device, a selection of a media asset from the first subset of the media assets;
generating for display, on the first user device, the selected media asset.

51. The method of any one of claims 42-50, further comprising:
receiving, at the second user device, a selection of a media asset from the second subset of the media assets;
generating for display, on the first user device, the selected media asset.
